(19) United States
(12) Patent Application Publication
(10) Pub. No.: US 2013/0214602 A1
(43) Pub. Date: Aug. 22, 2013

(54) METHOD AND SYSTEM FOR GENERATOR CONTROL

(71) Applicants: Gene Frohman, Woodbridge, CT (US); Christopher J. Vaum, Wilton, CT (US); Brian Bassett, Oxford, CT (US)

(72) Inventors: Gene Frohman, Woodbridge, CT (US); Christopher J. Vaum, Wilton, CT (US); Brian Bassett, Oxford, CT (US)

(73) Assignee: Engineered Electric Company, Bridgeport, CT (US)

(21) Appl. No.: 13/400,532

(22) Filed: Feb. 20, 2012

(51) Int. Cl. H02J 3/00

(52) U.S. Cl. 307/52

(57) ABSTRACT

In certain embodiments, the present invention includes a system for generator set control comprising a controller and two or more power generators configured to supply power to an electrical load. The two or more power generators are coupled to the controller, where the controller is configured to synchronize the two or more power generators with one another. In some embodiments, the controller is configured to automatically shut off or turn on at least one of the two or more power generators in response to the electrical load to increase the overall power efficiency of the system. In further embodiments, the system is configured to operate in ambient temperature environments ranging from −55° C. to +125° C. The controller can be a digital controller, analog controller, or a combination therewith. Furthermore, the system can be configured to operate in a micro-grid array.

### CROSS-REFERENCES TO RELATED APPLICATIONS

The following regular U.S. patent application and provisional applications, including this application, are being filed concurrently and the entire disclosure of the other applications is incorporated by reference into this application for all purposes:
Application Ser. No. ______, filed Feb. 20, 2012, entitled “METHOD AND SYSTEM FOR GENERATOR CONTROL” (Attorney Docket No. 92741-815045(001200US)) (regular U.S. patent application);
Application Ser. No. ______, filed Feb. 20, 2012, entitled “POWER DISTRIBUTION UNIT FOR POWER GRID MANAGEMENT” (Attorney Docket No. 92741-832341 (014600US)) (U.S. provisional patent application); and
Application Ser. No. ______, filed Feb. 20, 2012, entitled “SYSTEM AND METHOD FOR GENERATOR SET MONITORING AND CONTROL IN A POWER GRID” (Attorney Docket No. 92741-832340(0014500US)) (U.S. provisional patent application).

### STATEMENT AS TO RIGHTS TO INVENTIONS MADE UNDER FEDERALLY SPONSORED RESEARCH OR DEVELOPMENT

Not Applicable

### BACKGROUND OF THE INVENTION

Electrical generators serve many purposes and are commonplace in locations off of urban or commercial power grids (e.g., rural areas) or in locations that require back up power in the event of a power outage. Some of these locations include hospitals (e.g., for emergency back up power), schools, military base camps, and the like. Electrical generators typically require fuel such as gas or propane to power the motors that generate the electricity.

It can be exorbitantly expensive to generate electricity and maintain power grids (e.g., micro-grids) in remote areas due to the costs associated with fuel transport to these remote sites. The fully burdened cost of fuel (FBCF), or the effective cost per gallon, is one metric that can be used to measure these costs. Although commercial gas prices in the United States typically fluctuate between $2 to $4 per gallon depending on the region, gas prices can be several orders of magnitude higher in some scenarios. For example, U.S. military base camps in some of the most remote and mountainous regions in Afghanistan have micro-grid power arrays that are critical to the success of military operations. These sites may have no established shipping channels or commercial trade routes. Furthermore, large fuel caravans cannot be protected from improvised explosive devices (IEDs) or enemy combatants on a regular basis. As a result, large amounts of fuel have to be airlifted into these remote base camps to run the power generators. The FBCF in some of these regions can be as high as $400-$600 per gallon when considering the transport costs, personnel involved, and in many cases, the cost of human life in the process of procuring these fuel stores.

In addition to the high FBCF numbers, some military generator arrays operate in highly inefficient parallel configurations. Parallel configurations can protect against power outages since the operative units can compensate for inoperative units. However, parallel configurations tend to run at very low efficiency rates with light electrical loads. This is because parallel generator set configurations typically keep all generators running even with nominal electrical loads. For example, one original equipment manufacturer provides the U.S. Army with over 100,000 military generator sets and, by the Army's best estimates, these units are operating at approximately 17% to 20% capacity on average. The high FBCF numbers coupled with low generator set efficiencies, spread over tens of thousands of units results in massive economic waste. Furthermore, many generator units fail due to harsh military environments including extreme temperatures, large pressurization deltas (e.g., airlifting generator units), and impact (e.g., ordinance impact, shock waves, etc.) As such, improving generator robustness, fuel efficiency and cost effectiveness in high FBCF regions is desirable.

### SUMMARY OF THE INVENTION

In certain embodiments, the present invention includes a system for generator set control comprising a controller and two or more power generators configured to supply power to an electrical load. The two or more power generators are coupled to the controller, where the controller is configured to synchronize the two or more power generators with one another. In some embodiments, the controller is configured to automatically shut off or turn on at least one of the two or more power generators in response to the electrical load to increase the overall power efficiency of the system. In further embodiments, the system is configured to operate in ambient temperature environments ranging from −55° C. to +125° C. The controller can be a digital controller, analog controller, or a combination therewith. Furthermore, the system can be configured to operate in a micro-grid array.

Some embodiments of the generator set control can include a battle short switch operable to maintain operation of the two or more power generators during a set of predetermined operating conditions including at least one of an over-voltage condition, an under-voltage condition, an over-current condition, or an under-current condition. In some embodiments, the generator set control further includes a display configured as an interface between a user and the controller, wherein the display comprises one or more heating elements to maintain a visibility of the display at temperatures down to −55 C. The controller can be operable to be controlled by a remote control device including one of a Bluetooth communication link, an infra-red (IR) communication link, Ethernet communication link, or radio-frequency (RF) communication link. In further embodiments, the system includes an external voltage bias coupled to the controller, where the external voltage bias is operable to provide a reference voltage to the controller.

A method of conserving fuel in a generator set is described herein. In certain embodiments, the method includes synchronizing the operating frequency of two or more power generators of the generator set. The method further includes controlling an amount of power supplied by the two or more generators to an electronic load. In some embodiments, the method includes automatically turning on or shutting off at least one of the two or more power generators based on a power requirement of the electronic load. In some cases, the method includes maintaining operation of the two or more generators when a battle short condition occurs. A battle short condition can occur when an over-voltage, over-current, under-voltage, or under-current condition exists.

In some embodiments, the at least one of the two or more power generators are turned on when a current number of generators that are turned on cannot supply the power requirement of the electronic load. In other cases, the at least one of the two or more power generators are turned off when a current number of generators that are turned on can supply power at a predetermined threshold above the power requirement of the electronic load. In one non-limiting example, the predetermined threshold is a maximum power that can be supplied by one power generator of the current number of generators that are turned on. In further embodiments, the method includes receiving operational commands from a remote control device to control the two or more power generators. In certain cases, the operation commands are received via data link which includes at least one of a Bluetooth communication link, an IR link, an RF link, or an Ethernet link.

Certain embodiments of the invention include a non-transitory computer-readable storage medium comprising a plurality of computer-readable instructions tangibly embodied on the computer-readable storage medium, which, when executed by a data processor, provides a method of conserving fuel in a generator set, the plurality of instructions including instructions that cause the data processor to synchronize the operating frequency of two or more power generators and instructions that cause the data processor to control an amount of power supplied by the two or more generators to an electronic load. In some embodiments, the non-transitory computer-readable storage medium further includes instructions that cause the data processor to automatically turn on or shut off at least one of the two or more power generators based on a power requirement of the electronic load. In some cases, at least one of the two or more power generators are turned on when a current number of generators that are turned on cannot supply the power requirement of the electronic load. Alternatively, at least one of the two or more power generators are turned off when a current number of generators that are turned on can supply power at a predetermined threshold above the power requirement of the electronic load. The predetermined threshold can be a maximum power that can be supplied by one power generator of the current number of generators that are turned on.

In further embodiments, the non-transitory computer-readable storage medium further includes instructions that cause the data processor to maintain operation of the two or more generators when a battle short condition occurs. The battle short condition can occur when at least one of an over-voltage, over-current, under-voltage, or under-current condition exists in the generator set system.

### BRIEF DESCRIPTION OF THE DRAWINGS

FIG. 1 is a simplified block diagram of a control system for a generator set, according to an embodiment of the present invention.

FIG. 2 is a simplified block diagram of a control system for a generator set, according to an embodiment of the present invention.

FIG. 3 is a simplified signal diagram 300 illustrating aspects of gen set power delivery in a distributed power grid, according to an embodiment of the present invention.

FIG. 4 is a simplified block diagram of a voltage control loop for a generator set, according to an embodiment of the present invention.

FIG. 5 is a simplified block diagram of a frequency control loop for a generator set, according to an embodiment of the present invention.

FIG. 6 is a simplified flow diagram illustrating aspects of a method of conserving fuel in a power grid array including a plurality of generator sets, according to an embodiment of the invention.

### DETAILED DESCRIPTION OF SPECIFIC EMBODIMENTS

Embodiments of the invention are generally directed to systems and methods of controlling a generator set.

In an embodiment, a system for generator set control includes a controller and two or more power generators configured to supply power to an electrical load. The two or more power generators are coupled to the controller, where the controller is configured to synchronize the two or more power generators with one another. The controller can be configured to automatically shut off or turn on at least one of the two or more power generators in response to the electrical load to increase the overall power efficiency of the system. In some embodiments, the system is configured to operate in ambient temperature environments ranging from −55° C. to +125° C. The controller can be a digital controller, analog controller, or a combination therewith. Moreover, the system can be configured to operate in a micro-grid array. In further embodiments, the system includes a battle short switch operable to maintain operation of the two or more power generators during a set of predetermined operating conditions including at least one of an over-voltage condition, an under-voltage condition, an over-current condition, or an under-current condition. In yet further embodiments, the generator set control further includes a display configured as an interface between a user and the controller, wherein the display comprises one or more heating elements to maintain a visibility of the display at temperatures down to −55 C. The controller can be operable to be controlled by a remote control device including one of a Bluetooth communication link, an infra-red (IR) communication link, Ethernet communication link, or radio-frequency (RF) communication link. In further embodiments, the system includes an external voltage bias coupled to the controller, where the external voltage bias is operable to provide a reference voltage to the controller.

There are myriad types of generators that produce electrical energy, which can include gas, LPG (propane), natural gas, diesel, and others. A diesel generator can be the combination of a diesel engine with an electrical generator (i.e., alternator) to generate electrical energy. Diesel generating sets can be used in places without connection to a power grid (e.g., rural areas), as an emergency back up power-supply, military applications (e.g., micro-grids), as well as for more complex applications such as peak-lopping, grid support and export to the power grid. The combination of a diesel engine, a generator and various auxiliary devices (e.g., control systems, circuit breakers, fuel pumps, etc.) can be referred to as a “generating set” or a “gen set.”

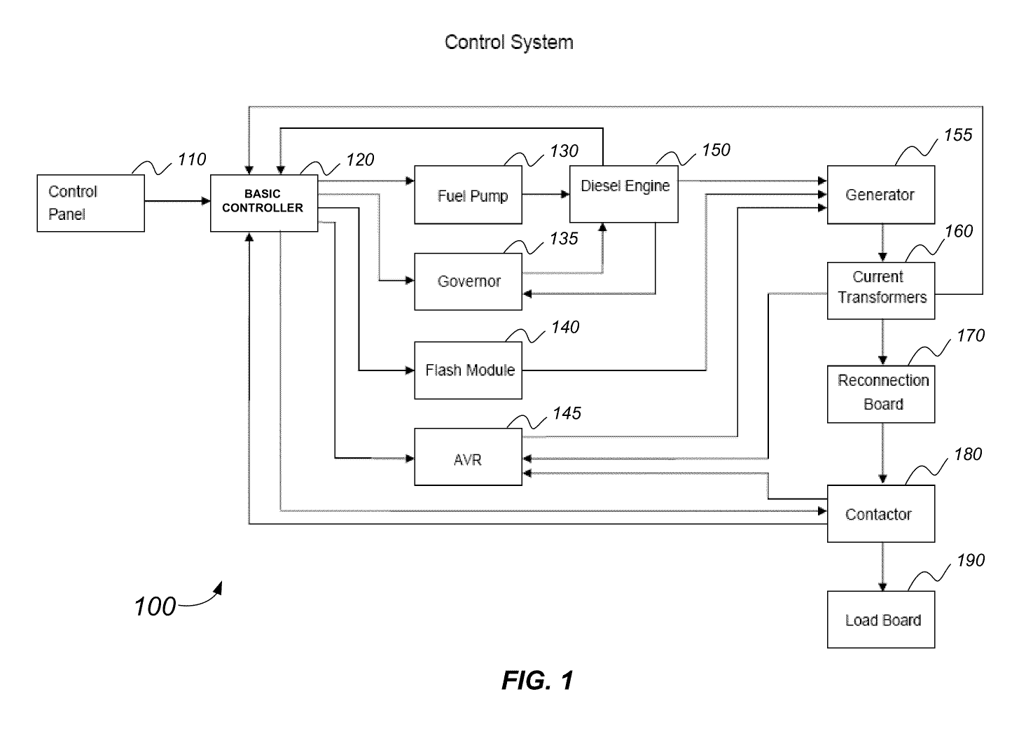

FIG. 1 is a simplified block diagram of a for a generator set 100, according to an embodiment of the present invention. The gen set 100 includes a control panel 110, a basic controller 120, a fuel pump 130, a governor 135, a flash module 140, an automatic voltage regulator (“AVR”) 145, a diesel engine 150, a generator 155, current transformer(s) 160, a reconnection board 170, a contactor 180, and a load board 190. The control panel 110 is electronically coupled to the basic controller 120. The basic controller 120 is electronically coupled to fuel pump 130, governor 135, flash module 140, AVR 145, diesel engine 150, current transformers 160 and contactor 180. The diesel engine 150 is also electronically coupled to the fuel pump 130, governor 135, and generator 155. The reconnection board is electronically coupled to the current transformers 160 and contactor 180. The contactor 180 is also electronically coupled to load board 190. In certain embodiments, the gen set 100 is battle hardened and configured to operate at military temperature specifications (−55° C. to +125° C.). In some cases, the gen set can be a tactical quiet generator (TQG). TQGs can be generator sets that are quieter than conventional gen sets, battle hardened and functional per military specifications, and can be implemented in tactical micro-grid configurations.

The basic controller 120 is configured to control various operational functions of the generator set described herein. The basic controller 120 can control the amount of fuel the fuel pump 130 delivers to the diesel engine 150. The basic controller 120 controls the governor 135. The governor 135 can be operable to measure and regulate the speed of the diesel engine 150. In some embodiments, the basic controller 120 controls the AVR 145 and contactor 180. For example, the contactor 180 can be used to connect a generator 155 to the load board 190. The basic controller 120 can further control the synchronization of the phase and frequency of multiple generators 155 as well as the amount of power generated by the generators 155. The basic controller 120 and its functions would be appreciated by one of ordinary skill in the art with the benefit of this disclosure

The current transformers 160 can be used to measure electric currents. More particularly, current transformers 160 can be used for measuring current and monitoring the operation of a power grid, micro-grid, and the like. For example, current transformers 160 can measure the current generated by generator(s) 155 in response to a given electrical load. In some cases, when current in a circuit is too high to directly apply to measuring instruments, a current transformer can produce a reduced current accurately proportional to the current in the circuit, which can be connected to measuring and recording instruments. A current transformer can also isolate the measuring instruments from high voltages in a monitored circuit. As described above, the current transformers provide feedback to the basic controller 120 to facilitate aspects of gen set 100 control and regulation.

The AVR 115 is an automatic voltage regulator configured to automatically maintain a constant voltage level (e.g., voltage reference) for the generator 155. The AVR 115 can be a simple “feed-forward” design or may include negative feedback control loops. The AVR 115 can use an electromechanical mechanism, or electronic components, and can be used to regulate one or more AC or DC voltages.

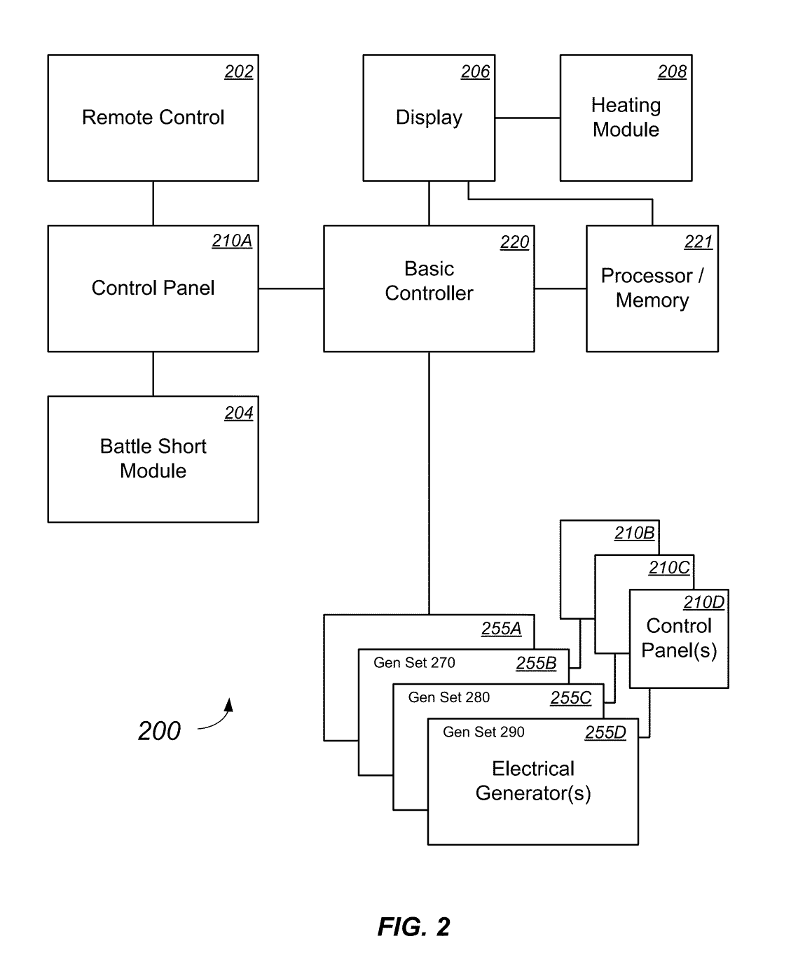

The control panel 110 controls the basic controller 120. The control panel 110 can add automated controls to connect and/or disconnect additional generators 155 to the generator set based on the power requirements of an electronic load. The control panel 110 can further provide for remote control access to the gen set 100, support battle short modes of operation, and provide for a distributed system architecture of gen set control. The control panel 110 is further discussed below with reference to FIG. 2. In certain embodiments, the control panel 120 comprises one or more microprocessors (μCs) and is configured to control the operation of the gen set 100. Alternatively, the control panel 120 may include one or more microcontrollers (MCUs), digital signal processors (DSPs), or the like, with supporting hardware/firmware (e.g., memory, programmable I/Os, etc.), as would be appreciated by one of ordinary skill in the art. In some embodiments, multiple processors may provide an increased performance. It should be noted that although multiple processors may improve the speed and bandwidth of gen set 100 performance, they are not required for standard operation of the embodiments described herein.

The flash module 140 is a memory module that can be accessed by the control panel 110 and basic controller 120. Although flash memory is depicted in FIG. 1, other types of suitable random access memory can be supplemented or substituted therein. For some non-limiting examples, the memory modules may be one of or a combination of random access memory (RAM) such as static RAM (SRAM), dynamic RAM (DRAM). Alternatively, the module 140 can include a programmable read-only memory (PROM), an erasable and programmable read-only memory (EPROM), an electrically erasable and programmable read-only memory (EEPROM), or the like.

The diesel engine 150 and generator(s) 155 generate electricity to provide a regulated power supply to a given electrical load. As described above, there are many types of generators that produce electrical energy (e.g., propane, gas, etc.) and the present invention is not limited to diesel embodiments. In exemplary embodiments, the gen set 100 can be configured to control multiple get set units in the 30 kW-60 kW output range, however the gen set 100 can also accommodate and control generators with a higher or lower output ranges.

FIG. 2 is a simplified block diagram of a gen set 200 for a generator set, according to an embodiment of the present invention. The gen set 200 can include some or all of the features described in FIG. 1, but are not shown to prevent obfuscation of some of the novel aspects of the present invention. The gen set 200 includes a control panel 210A, a basic controller 220, a remote gen set 202, a battle short module 204, a generator 255A, a display 206 and a heating element 208. FIG. 2 further includes gen sets 270, 280, and 290 which include electrical generators 255B-255D coupled to control panels 210B-210D, respectively. Each of the generators (e.g., 255A-D) is configured with its own dedicated control panel and gen set system.

FIG. 2 also illustrates a processor/memory 221, which can be a computer that provides, among other functions, control over basic controller 220. The processor/memory 221 can be a stand alone single board computer (SBC), it can be integrated in the control panel 210A, or other architectural configuration that would be appreciated by one of ordinary skill in the art. Display 206 is configured to provide user input/output for the processor/memory 221. In certain embodiments, the SBC 221 and display 206 are connected to the basic controller 220. The display 206 can be a color display, monochromatic, high definition, or any type as required. In some embodiments, a separate display can be utilized with the SBC 221.

The SBC 221 extends the capability of the basic controller 220 to allow system operational data to be logged internally in the generator. As further described below, the SBC 221 can be connected to a high resolution color display 206 that works over a wide military temperature range and is heated from behind (e.g., heating module 208) to allow operation at low temperature beyond what is normally possible for displays of this type. The SBC 221 further extends the functionality of the basic controller 220 by allowing setups for multiple generator voltages and frequencies to be automatically uploaded to the basic controller 220 when the configuration of the generator 200 is changed. A web server (not shown) can be incorporated into the SBC 221 to allow data to be downloaded from the SBC 221 using a web browser on another computer connected to the SBC 221 by hard-wired or wireless Ethernet connections. The data directory on the SBC 221 can also accessible, for example, via a Windows share over the network and remotely controlled by another computer using a VNC (Virtual Network Computing) viewer. Although the SBC 221 is not limited in the applications that it can run, some applications can include programs that provide for an internet connection, virtual client capabilities, and configuration data for reboot. Some of the capabilities provided by the SBC 221 include data logging to track operational data of the gen set (e.g., power output, efficiency, oil levels, water temperature, etc.), a user interface application to allow for remote control of the basic controller 220 and integration of the other applications (similar to remote control module 202), an application to display user manuals and troubleshooting guides, and a condition-based maintenance alert system to allow the connection of sensors in the generator 255A to the SBC 221 to determine when service items need to be replaced based on their condition and/or their timed cycles. Furthermore, the SBC 221 can be a gateway for several different communications protocols including Ethernet, Modbus TCP, CAN Open and CANJ1939.

In certain embodiments, the control panel 210A can be retrofitted to replace an existing generator control box requiring no external components, while maintaining the same size, fit, form factor, and control functionality. In some non-limiting examples, the control panel 210 can be used to implement a tactical micro-grid with a plug-and-play swap of the original equipment control box of DRS-Fermont™ gen sets, 30 kW-60 kW gen set units manufactured by L3 Communications MCII Electric Division™, AMMPS generators manufactured by Cummins-Onan™, and others. In some embodiments, the control panel 210A can be implemented in new gen set units without replacing existing control units. In further embodiments, the control panel 210A can be battle-hardened to pass all military qualification testing (“mil specs”) including temperature requirements (e.g., −55° C. to +125° C.) and other mil spec metrics that would be appreciated by one of ordinary skill in the art.

The control panel 210A is configured as a system integrator. In addition to controlling the gen set 200, the control panel 210A is operable to communicate with other gen set systems in a distributed network to start/stop a given number of gen sets to accommodate a certain power load on the power grid. Certain embodiments of the invention may include a digital control panel 210A, however analog or digital/analog hybrids can be implemented. The control panel 210A is configured for plug-and-play operation and cleanly integrates into the gen set 200, as described above. In some cases, the control panel 210A is configured to replace existing control panels in a plug-and-play drop-in configuration (e.g., older model DRS-Fermont gen sets using original equipment control panels, etc.). In other cases, the control panel 210A can be original equipment controllers in new gen set systems.

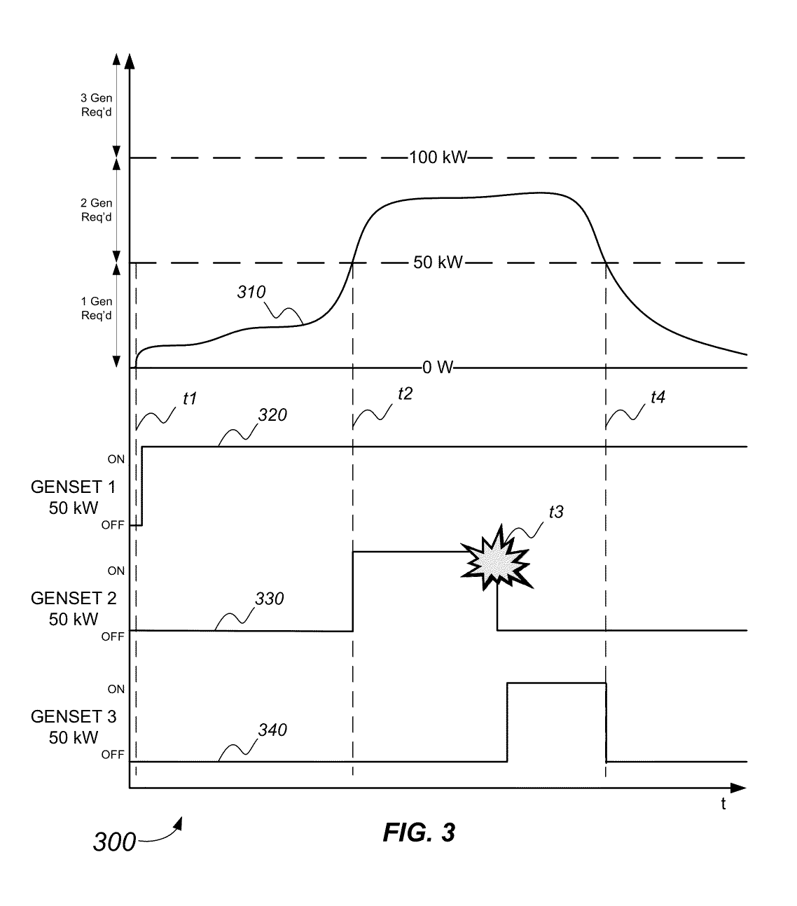

In distributed control systems, each gen set is independent and configured as equal entities with respect to each other such that any generator set in the system can still operate even if other gen sets are disabled. This is different than conventional master/slave configurations, which can be problematic if the master unit fails. Distributed systems provide for a robust and reliable power grid architecture because if one generator fails, shuts down, or is destroyed, other generators in the power grid will automatically come on-line to accommodate the particular power requirements of the electrical load. In other words, each of the gen sets operate independently from one another but communicate and coordinate power delivery with the other gen sets in the distributed power grid system. This concept is further described below with respect to FIG. 3.

Circuit breakers are typically found on generators and are operable to shut down the generator during an electrical fault condition (e.g., short circuit) to protect the generator from damage. In some cases, maintaining the operation of the generator 255A and providing an uninterrupted power source to a power load can be of paramount importance, even at the risk of damaging the generator set 200. This may be true, for example, during critical military operations. A battle short module 204 causes the generator 255A to continuously run even though a fault condition may exist, by bypassing the protection units in the gen set 200 (e.g., circuit breakers). Some fault conditions may include an over-temperature condition, over voltage condition, under voltage condition, over current condition, or under current condition. The battle short module 204 can be engaged via the control panel 210A or it can operated independently as a stand alone unit. Furthermore, the battle short module 204 can be activated remotely from remote control module 202 or similarly wireless means. The battle short module 204 can be activated by mechanical switch, soft switch, though a graphical interface unit (GUI) such as an interactive display 206, or the like.

The remote control module 202 allows for remote access and control to the control panel 210A. This can be useful in certain applications where the control panels 210A are at long distances (e.g., a kilometer) from the generator 255A. Remote access to the control module 210A can also be useful to remotely activate the battle short module 204, for example, at a central command station. Any suitable communications protocol can be used (e.g., Modbus, CANbus, etc.), as would be known by those of ordinary skill in the art.

The display 206 can be a visual interface for a user to interact and control the gen set 200. The display 206 can be an active touch-sensitive graphical user interface (GUI), passive display, basic terminal, or any suitable visual interface. The display 206 is controlled by the control panel 210A via the basic controller 220. Alternatively, the control panel 210A can directly access and control the display 206. The gen set 200 is battle hardened (e.g., shock wave resistant) and operable at temperatures down to −55 degrees Celsius. At sub-zero temperatures, displays or monitors can become foggy and/or iced over, making monitoring and viewing the display 206 difficult or impossible. In some cases, the display 206 can become damaged, shattered, or inoperable due to condensation and the expansion and/or contraction caused by extreme temperature conditions. In some embodiments, a heating module 208 is coupled to the display 206. The heating module 208 can include heating elements (e.g., heater coils, heat sinks, etc.) configured in proximity to the display 206 (e.g., below, around the edges, etc.). The heating module 208 heats the display 206 to melt ice, evaporate condensation, etc., to provide for a clear and unobstructed viewing area in extreme sub-zero temperatures. In some embodiments, the heating module 208 can be controlled from the control panel 210A, from the display (e.g., by soft keys, mechanical buttons, or the like), via the remote control module 202, or through any other suitable means.

FIG. 3 is a simplified signal diagram 300 illustrating aspects of gen set power delivery in a distributed power grid, according to an embodiment of the present invention. The distributed power grid is configured to dynamically and automatically power up/power down gen sets in response to a varying power load requirement. The signal diagram 300 includes a power load curve (“power load”) 310, a gen set 1 signal 320, a gen set 2 signal 330, a gen set 3 signal 340, a first time (t1), a second time (t2), a third time (t3), and a fourth time (t4). In this example, each gen set is rated for a 50 kW output, however other gen set sizes can be used. The power load 310 remains below 50 kW from t1 and t2, between 50 kW and 100 kW from t2 and t3, and below 50 kW after t3. In this particular example, one generator is required to supply up to 50 kW, two generators are required to supply 50 kw-100 kW, and three generators are required to supply 100 kW to 150 kW. The generators are stopped and started by their respective control panels based on load demand. It should be noted that these values are selected for illustrative purposes only and any other number of gen sets, power ratings, and combination or configuration of gen sets can be used and required.

According to FIG. 3, prior to t1, there is no electrical load and all gen sets in the power grid (e.g., gen sets 1-3) are shut off. At time t1, the power load 310 operates at roughly 10 kW and begins increasing. In response to the power load 310, the control panel of gen set 1 automatically starts its generator and provides the requisite power of the power load 310. As shown, the power load 310 remains below 50 kW between t1 and t2. Gen sets 2 and 3 remain off during this period.

At time t2, the power load 310 rises above 50 kW. The control panel of gen set 2 automatically starts, synchronizes its operating phase and frequency to gen set 1, and closes its breaker on the power grid. Gen set 2 supplements the power grid output to meet the power load 310 requirement as it remains between 50 kW and 100 kW. At time t3, gen set 2 is rendered inoperable (e.g., catastrophic electrical failure, destroyed, etc.) and is brought offline. As discussed above, Gen set 1 remains online but can only provide up to 50 kW output. The power grid detects the shut down of gen set 2 and automatically activates gen set 3. The control panel of gen set 3 starts up the generator, synchronizes its operating phase and frequency to gen set 1, and closes its breaker on the power grid. Gen set 3 supplements the power grid output to meet the power load 310 requirement as it remains between 50 kW and 100 kW. At time t4, the power load requirement 310 drops below 50 kW. The distributed power grid opens the gen set 3 circuit breaker and powers it down while gen set 1 continues to provide power to the electrical load. As described above, each generator set includes a control panel and basic controller to synchronize and control the other generator sets of the power grid.

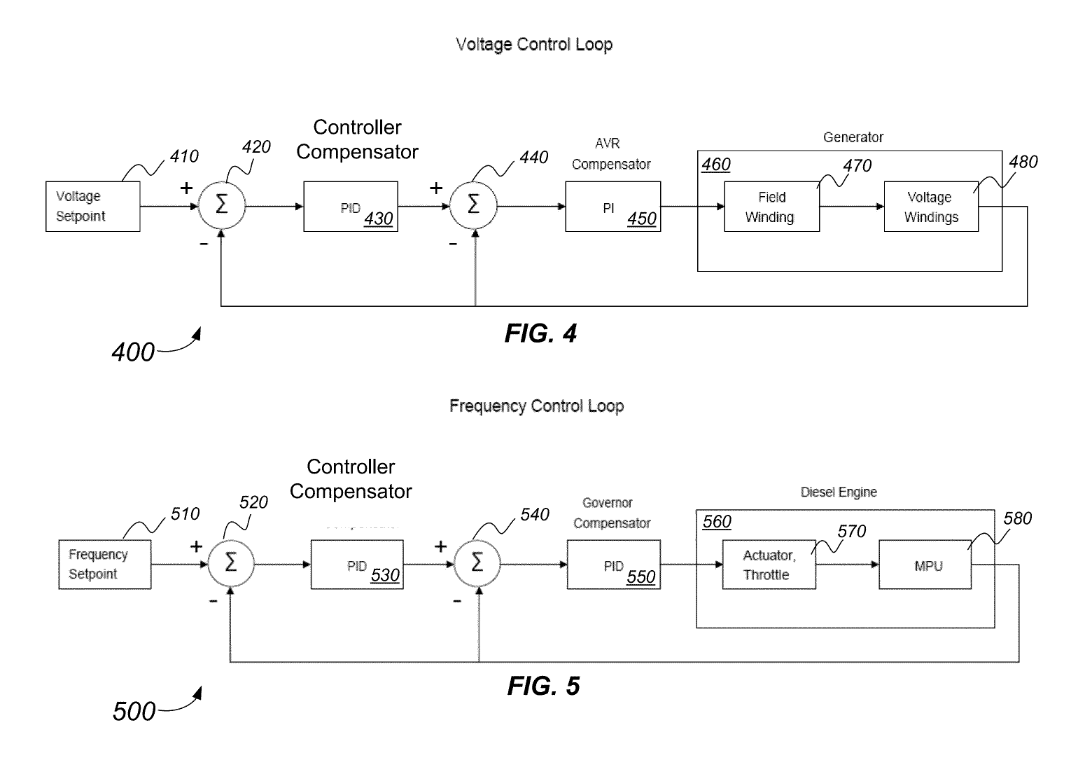

FIG. 4 is a simplified block diagram of a voltage control loop 400 for a generator set, according to an embodiment of the present invention. The voltage control loop 400 includes a voltage set point 410, a first summer circuit 420, a controller compensator 430, a second summer circuit 440, an AVR compensator 450, and a generator 460. The generator 460 further includes a field winding 470 and voltage windings 480. The first summer circuit 420 receives a voltage input from the voltage set point 410 and feedback (e.g., current or voltage) from the generator 460. The second summer circuit 440 receives a voltage input from the controller compensator 430 and feedback (e.g., current or voltage) from the generator 460. The operation of the voltage control loop 500 would be known by one of ordinary skill in the art with the benefit of this disclosure

FIG. 5 is a simplified block diagram of a frequency control loop 500 for a generator set, according to an embodiment of the present invention. The frequency control loop 500 includes a frequency set point 510, a first summer circuit 520, a controller compensator 530, a second summer circuit 540, a governor compensator 550, and a diesel engine 560. The diesel engine 560 further includes a actuator throttle 570 and a mobile power unit (MPU) 580. The first summer circuit 520 receives a frequency input from the frequency set point 510 and feedback (e.g., current or voltage) from the diesel engine 560. The second summer circuit 540 receives an input from the controller compensator 530 and feedback (e.g., current or voltage) from the diesel engine 560. The operation of the frequency control loop 500 would be known by one of ordinary skill in the art with the benefit of this disclosure

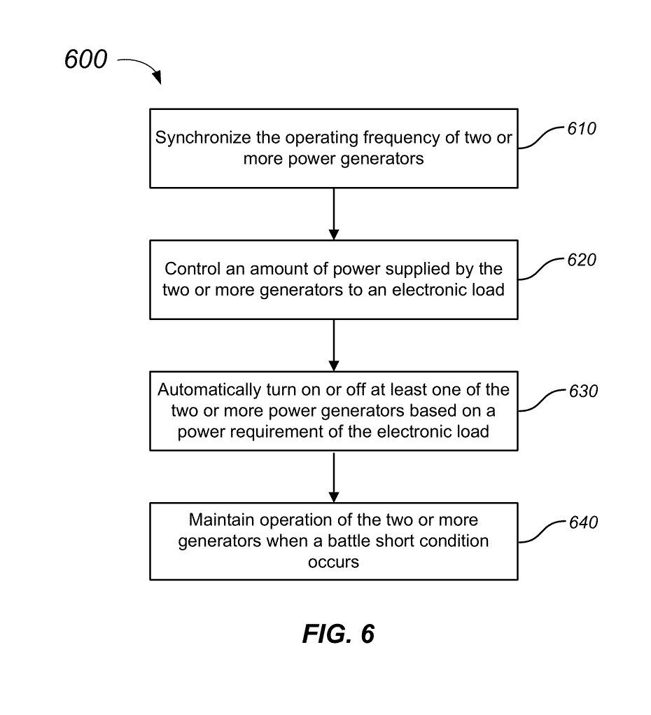

FIG. 6 is a simplified flow diagram illustrating aspects of a method 600 of conserving fuel in a power grid array including a plurality of generator sets, according to an embodiment of the invention. The method 600 is performed by processing logic that may comprise hardware (e.g., circuitry, dedicate logic, etc.), software (which as is run on a general purpose computing system or a dedicated machine), firmware (embedded software, or any combination thereof. In one embodiment, the method 600 is performed by the control circuit(s) 210 of each gen set in a distributed power grid by collectively communicating and coordinating power delivery to an electronic power load.

Referring to FIG. 6, the method 600 includes synchronizing the operating frequency of two or more power generators (610) to meet a specific electronic power load requirement. At 620, the method further includes controlling an amount of power supplied by the two or more generators to an electronic load. At 630, the method automatically turns on or off at least one of the two or more power generators based on a power requirement of the electronic power load. At 640, the power grid maintains the operation of the two or more generators when a battle short condition occurs.

It should be appreciated that the specific steps illustrated in FIG. 6 provides a particular method of conserving fuel in a generator set, according to an embodiment of the present invention. Other sequences of steps may also be performed according to alternative embodiments. In certain embodiments, the method 600 may perform the individual steps in a different order, at the same time, or any other sequence for a particular application. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of the method.

It should be noted that certain embodiments of the present invention can perform some or all of the functions described herein. For example, some embodiments can perform all of the functions described in FIGS. 1-6, while others may be limited a one or two of the various functions described herein.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A system for generator set control comprising:
a controller; and
two or more power generators configured to supply power to an electrical load, wherein the two or more power generators are coupled to the controller, wherein the controller is configured to synchronize the two or more power generators with one another, wherein the controller is configured to automatically shut off or turn on at least one of the two or more power generators in response to the electrical load to increase the overall power efficiency of the system, and wherein the system is configured to operate in ambient temperature environments ranging from −55° C. to +125° C.

2. The system of claim 1 wherein the controller is a digital controller.

3. The system of claim 1 further comprising a battle short switch operable to maintain operation of the two or more power generators during a set of predetermined operating conditions including at least one of an over-voltage condition, an under-voltage condition, an over-current condition, or an under-current condition.

4. The system of claim 1 further comprising a display configured as an interface between a user and the controller, wherein the display comprises one or more heating elements to maintain a visibility of the display at temperatures down to −55 C.

5. The system of claim 1 wherein the controller is operable to be controlled by a remote control device.

6. The system of claim 5 wherein the remote control device communicates with the controller by one of a Bluetooth communication link, an infra-red (IR) communication link, Ethernet communication link, or radio-frequency (RF) communication link.

7. The system of claim 1 wherein the system is configured to operate in a micro-grid array.

8. The system of claim 1 further comprising an external voltage bias coupled to the controller, wherein the external voltage bias is operable to provide a reference voltage to the controller.

9. A method of conserving fuel in a generator set, the method comprising:
synchronizing the operating frequency of two or more power generators;
controlling an amount of power supplied by the two or more generators to an electronic load;
automatically turning on or shutting off at least one of the two or more power generators based on a power requirement of the electronic load; and
maintaining operation of the two or more generators when a battle short condition occurs.

10. The method of claim 9 wherein the at least one of the two or more power generators are turned on when a current number of generators that are turned on cannot supply the power requirement of the electronic load.

11. The method of claim 9 wherein the at least one of the two or more power generators are turned off when a current number of generators that are turned on can supply power at a predetermined threshold above the power requirement of the electronic load.

12. The method of claim 9 wherein the predetermined threshold is a maximum power that can be supplied by one power generator of the current number of generators that are turned on.

13. The method of claim 9 wherein the battle short condition occurs when an over-voltage, over-current, under-voltage, or under-current condition exists.

14. The method of claim 9 further comprising receiving operational commands from a remote control device to control the two or more power generators.

15. The method of claim 14 wherein the operation commands are received via data link which includes at least one of a Bluetooth communication link, an IR link, an RF link, or an Ethernet link.

16. A non-transitory computer-readable storage medium comprising a plurality of computer-readable instructions tangibly embodied on the computer-readable storage medium, which, when executed by a data processor, provides a method of conserving fuel in a generator set, the plurality of instructions comprising:
instructions that cause the data processor to synchronize the operating frequency of two or more power generators;
instructions that cause the data processor to control an amount of power supplied by the two or more generators to an electronic load;
instructions that cause the data processor to automatically turn on or shut off at least one of the two or more power generators based on a power requirement of the electronic load; and
instructions that cause the data processor to maintain operation of the two or more generators when a battle short condition occurs.

17. The non-transitory computer-readable storage medium of claim 16 wherein the at least one of the two or more power generators are turned on when a current number of generators that are turned on cannot supply the power requirement of the electronic load.

18. The non-transitory computer-readable storage medium of claim 16 wherein the at least one of the two or more power generators are turned off when a current number of generators that are turned on can supply power at a predetermined threshold above the power requirement of the electronic load.

19. The non-transitory computer-readable storage medium of claim 16 wherein the predetermined threshold is a maximum power that can be supplied by one power generator of the current number of generators that are turned on.

20. The non-transitory computer-readable storage medium of claim 16 wherein the battle short condition occurs when at least one of an over-voltage, over-current, under-voltage, or under-current condition exists.
